(19) United States
(12) Patent Application Publication
(10) Pub. No.: US 2026/0075154 A1
(43) Pub. Date: Mar. 12, 2026

(54) IMAGE FORMING APPARATUS, CONTROL METHOD, AND SYSTEM

(71) Applicant: SHARP KABUSHIKI KAISHA, Sakai City (JP)

(72) Inventor: NORIKAZU INAMI, Sakai City (JP)

(21) Appl. No.: 19/324,555

(22) Filed: Sep. 10, 2025

(30) Foreign Application Priority Data
Sep. 11, 2024 (JP) 2024-157082

(51) Int. Cl. H04N 1/32; H04N 1/00

(52) U.S. Cl. CPC H04N 1/32496; H04N 1/00474; H04N 1/00411; H04N 2201/0075; H04N 2201/0094

(57) ABSTRACT

An image forming apparatus that is remotely operable by an information processing apparatus including a first display that displays a first operation image as a remote operation image, the image forming apparatus includes: a second display that displays a second operation image as an image forming apparatus operation image for operation of the image forming apparatus; a communicator that communicates with the information processing apparatus; a display storage in which the first operation image is loaded; and one or more controllers that transmit the first operation image including the second operation image as a part of the first operation image to the information processing apparatus when a resolution of the first display is higher than a resolution of the second display.

### CROSS-REFERENCE TO RELATED APPLICATION

The present application claims priority from Japanese Application JP 2024-157082, the content to which is hereby incorporated by reference into this application.

### BACKGROUND OF THE INVENTION

### Field of the Invention

The present disclosure relates to an image forming apparatus, a control method, and a system.

### Description of the Related Art

In the related art, a remote operation system is used in which an apparatus (for example, a multifunction peripheral or an information processing apparatus) installed at a remote location is remotely operated by another apparatus (for example, an information processing apparatus or a portable information terminal) connected via a network.

A remote operation system is known that includes an information processing apparatus and a portable information terminal in which the portable information terminal receives image information displayed on a display screen included in the information processing apparatus and displays the image information on a display screen of the portable information terminal.

### SUMMARY OF THE INVENTION

In a remote operation system, when a multifunction peripheral is remotely operated from another apparatus, a remote operation application executed by the other apparatus generally displays an operation screen similar to an operation screen displayed on an operation panel of the multifunction peripheral on a display of the other apparatus as a remote operation panel. However, in a case where the operation panel of the multifunction peripheral is small and the displayed operation screen is created for a small operation panel, when the operation screen similar to the operation screen displayed on the operation panel of the multifunction peripheral is displayed as the remote operation panel on the display of the other apparatus as one screen as it is, screen switching frequently occurs because an amount of information to be displayed is small, and there is a risk that operations become complicated.

In addition, in a remote operation system of the related art, a size of a display screen of a portable information terminal that receives screen information is smaller than a size of a display screen of an information processing apparatus to be remotely operated. An object of the remote operation system of the related art is to improve operability in such a case, but a case is not considered where the size of the display screen of the portable information terminal that receives the screen information is larger than the size of the display screen of the information processing apparatus to be remotely controlled.

An object of an aspect of the present disclosure is to provide an image forming apparatus and the like for improving operability at the time of remote operation.

An image forming apparatus according to an aspect of the present disclosure is an image forming apparatus that is remotely operable by an information processing apparatus including a first display that displays a first operation image as a remote operation image, the image forming apparatus including a second display that displays a second operation image as an image forming apparatus operation image for operation of the image forming apparatus, a communicator that communicates with the information processing apparatus, a display storage in which the first operation image is loaded, and one or more controllers that transmit the first operation image including the second operation image as a part of the first operation image to the information processing apparatus when a resolution of the first display is higher than a resolution of the second display.

A control method according to an aspect of the present disclosure is a control method for an image forming apparatus that is remotely operable by an information processing apparatus including a first display that displays a first operation image as a remote operation image, the image forming apparatus including a second display that displays a second operation image as an image forming apparatus operation image for operation of the image forming apparatus, the control method including processing of communicating with the information processing apparatus, loading the first operation image, and transmitting the first operation image including the second operation image as a part of the first operation image to the information processing apparatus when a resolution of the first display is higher than a resolution of the second display.

A system according to an aspect of the present disclosure is a system including an image forming apparatus and an information processing apparatus allowed to remotely operate the image forming apparatus, wherein the information processing apparatus includes a first communicator that receives a first operation image as a remote operation image that remotely operates the image forming apparatus, a first display that displays the first operation image, and a processor that remotely operates the image forming apparatus via the first operation image, the image forming apparatus includes a second display that displays a second operation image as an image forming apparatus operation image for operation of the image forming apparatus, a second communicator that communicates with the information processing apparatus, a display storage in which the first operation image is loaded, and one or more controllers that transmit the first operation image including the second operation image as a part of the first operation image to the information processing apparatus when a resolution of the first display is higher than a resolution of the second display.

According to the image forming apparatus and the like of the present disclosure, it is possible to improve operability at the time of remote operation.

### BRIEF DESCRIPTION OF THE DRAWINGS

FIG. 1 is a configuration diagram of a system according to an embodiment.

FIG. 2 is a functional block diagram of an MFP according to the embodiment.

FIG. 3 is a functional block diagram of a PC according to the embodiment.

FIG. 4 is a diagram illustrating an example of screen data loaded in a display storage.

FIG. 5 is an example of a real machine operation image displayed on a display of the MFP.

FIG. 6 is an example of a remote operation image displayed on the display of the PC.

FIG. 7 is an example of the remote operation image displayed on the display of the PC.

FIG. 8 is an example of the remote operation image displayed on the display of the PC.

FIG. 9 is an example of the remote operation image displayed on the display of the PC.

FIG. 10 is a sequence diagram illustrating a control method of a system according to the embodiment.

### DETAILED DESCRIPTION OF THE INVENTION

An embodiment will be described below with reference to the drawings. Note that in the drawings, the same or equivalent elements are denoted by the same reference signs, and redundant descriptions will be omitted.

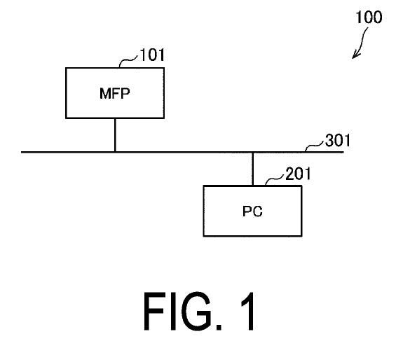

FIG. 1 is a configuration diagram of a system according to the embodiment.

A system 100 includes a multifunction peripheral (MFP) 101 and a personal computer (PC) 201. The MFP 101 and the PC 201 are connected to each other via a network 301 such as a local area network (LAN) and can communicate with each other. The MFP 101 is an example of an image forming apparatus. The PC 201 is an example of an information processing apparatus.

The MFP 101 has a plurality of functions (modes) such as scanning, printing, copying, and faxing of a document. The MFP 101 receives a print job including print data such as characters and images to be printed and print setting information from the PC 201, and performs printing based on the print data included in the print job.

The PC 201 creates print data including, for example, a document, a table, an image, print setting information, and the like, and transmits a print job including the created print data to the MFP 101. A remote operation application is installed in the PC 201, and the MFP 101 can be remotely operated by executing the remote operation application.

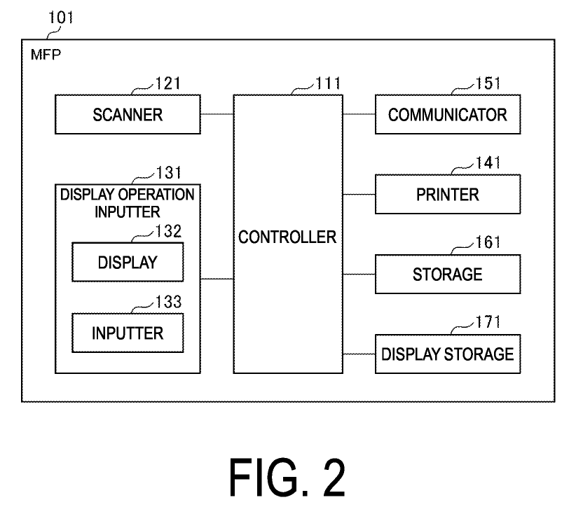

FIG. 2 is a functional block diagram of the MFP according to the embodiment.

The MFP 101 includes a controller 111, a scanner 121, a display operation inputter 131, a printer 141, a communicator 151, a storage 161, and a display storage 171.

The controller 111 performs control of the MFP 101 such as scanning, printing, and copying. The controller 111 is implemented by, for example, one or more processors such as central processing units (CPUs), or one or more logic circuits (hardware) formed in an integrated circuit (IC) chip, or the like.

The scanner 121 reads out a document placed on a document table (not illustrated) of the MFP 101 or the like, or a document transported by a document transport device (not illustrated) to generate image data of the read document.

The display operation inputter 131 displays various types of information and receives an operation input from a user. The display operation inputter 131 is, for example, a touch panel. The display operation inputter 131 includes a display 132 and an inputter 133. The display 132 performs various types of display according to display control signals from the controller 111. The display 132 is, for example. a liquid crystal display, an organic electro-luminescence (EL) display, or the like. A resolution of the display 132 is lower than a resolution of the display 231 of the PC 201, which will be described below. The resolution of the display 132 is, for example, 480 pixels by 360 pixels. The inputter 133 is, for example, a position input device, and detects coordinates of a contact position with a finger, a touch pen, or the like at the inputter 133, and outputs the detected coordinates to the controller 111. Further, in the inputter 133, hardware keys such as operation buttons may be used.

The printer 141 prints characters, images, and the like on a recording medium such as a paper supplied from a feeder (not illustrated) based on print data included in a print job received from the PC 201 via the communicator 151 or print data stored in the storage 161.

The communicator 151 communicates with the PC 201 under the control of the controller 111, and performs data-conversion accompanying the communication. The communicator 151 is, for example, a wired communication interface or a wireless communication interface, and specifically, is, for example, a communication interface such as Ethernet (trade name) or Wi-Fi (trade name).

The storage 161 stores various programs and various types of data necessary for operating the MFP 101. The storage 161 may be constituted by, for example, one or more storage devices such as random access memories (RAM), hard disk drives (HDD), solid state drives (SSD), or read only memories (ROM).

In the display storage 171, data of a screen displayed on the display 132, and, at the time of remote operation, on the display 231 of the PC 201 described below is loaded (stored). In the embodiment, since the resolution of the display 231 is higher than the resolution of the display 132, and a remote operation image displayed on the PC 201 has a higher resolution than that of an operation image displayed on the display 132, a capacity (region) of the display storage 171 is larger than a capacity required for loading the operation image displayed on the display 132. To be more specific, the capacity of the display storage 171 is a size that allows the remote operation image displayed on the PC 201 to be loaded.

For example, at the time of remote operation, the controller 111 reads out the remote operation image from the display storage 171 and transmits the remote operation image to the PC 201 via the communicator 151, and the PC 201 displays the remote operation image on the display 231. For example, when displaying the operation screen on the display 132, the controller 111 uses screen data (a real machine operation image) of the operation screen loaded in the display storage 171 to display the real machine operation image as the operation screen on the display 132. Note that the remote operation image displayed on the PC 201 is designed to include the operation screen displayed on the display 132, and a part of the remote operation image loaded in the display storage 171 serves as the real machine operation image displayed on the display 132. The display storage 171 can be configured by one or more storage devices, for example, RAMs and the like.

Note that in the embodiment, the display storage 171 is provided separately from the storage 161, but the storage 161 may include the display storage 171, and the storage 161 may operate as the display storage 171. Further, the display operation inputter 131 may include the display storage 171.

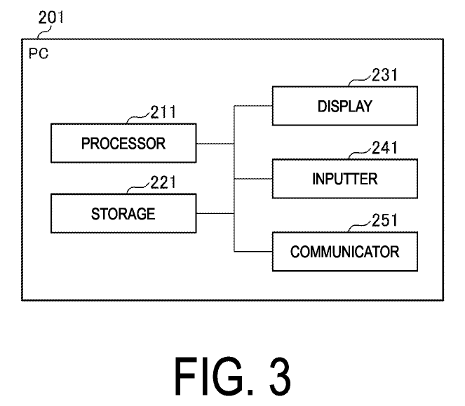

FIG. 3 is a functional block diagram of the PC according to the embodiment.

The PC 201 includes a processor 211, a storage 221, the display 231, an inputter 241, and a communicator 251.

The processor 211 controls the PC 201. The processor 211 is implemented by, for example, one or more processors such as CPUs. The processor 211 executes the remote operation application to communicate with the MFP 101 and remotely operate the MFP 101.

The storage 221 stores various programs and various types of data necessary for operating the PC 201. The storage 221 stores the remote operation application for remotely operating the MFP 101. The storage 221 can be configured by one or more storage devices such as RAMs, HDDs, SSDs, and ROMs, for example.

The display 231 performs various types of display. The display 231 is, for example, a liquid crystal display, an organic EL display, or the like. The resolution of the display 231 is higher than the resolution of the display 132 of the MFP 101. The resolution of the display 231 is, for example, 1920 pixels by 1080 pixels.

The inputter 241 receives an input of an operation from the user or an input of various types of information. The inputter 241 is, for example, a keyboard, a mouse, a touch pad, or the like.

The communicator 251 communicates with the MFP 101 under the control of the processor 211, and performs data-conversion accompanying the communication. The communicator 251 is, for example, a wired communication interface or a wireless communication interface, and specifically, is, for example, a communication interface such as Ethernet (trade name) or Wi-Fi (trade name).

When the MFP 101 is remotely operated, the processor 211 communicates with the MFP 101 by reading out the remote operation application from the storage 221 for execution, the communicator 251 receives the remote operation image from the MFP 101, and the processor 211 displays the remote operation image on the display 231. The processor 211 remotely operates the MFP 101 using the remote operation image.

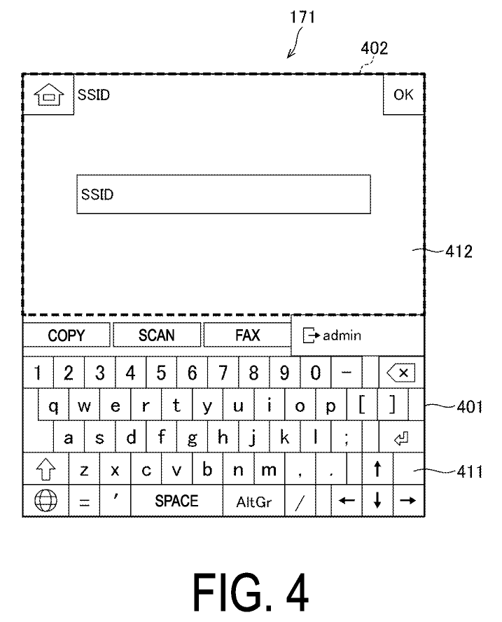

FIG. 4 is a diagram illustrating an example of the screen data loaded in the display storage.

In the display storage 171, the operation image corresponding to a second operation image displayed on the display 132 of the MFP 101 (the real machine operation image corresponding to an image forming apparatus operation image) and the remote operation image corresponding to a first operation image displayed on the PC 201 at the time of remote operation are loaded. Specifically, a remote operation image 411 is loaded in a region 401 indicated by a solid line in the display storage 171. Further, a real machine operation image 412 is a part of the remote operation image 411, and an image in a region 402 indicated by a broken line in the region 401 serves as the real machine operation image 412. The real machine operation image 412 in FIG. 4 is a service set identifier (SSID) setting screen. Note that an image in a region other than the region 402 in the region 401 corresponding to a third operation image is an image included in the remote operation image 411 when the resolution of the display 231 is higher than the resolution of the display 132, and is an image based on the real machine operation image different from the real machine operation image 412 in the region 402.

Next, display on the display 132 of the MFP 101 will be described.

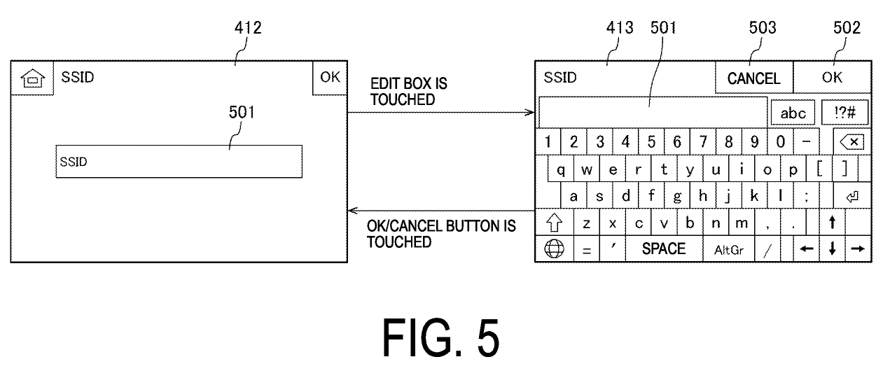

FIG. 5 is an example of the real machine operation image displayed on the display of the MFP. To be more specific, FIG. 5 illustrates the SSID setting screen displayed on the display 132 of the MFP 101. When displaying on the display 132, the controller 111 reads out screen data (the real machine operation image 412) loaded in the region 402 of the display storage 171, and displays the real machine operation image 412 on the display 132. That is, a part of the remote operation image 411 loaded in the display storage 171 is cut out and displayed on the display 132. As a result, the real machine operation image 412 illustrated on a left side of FIG. 5 is displayed on the display 132. The real machine operation image 412 is provided with an edit box 501 for inputting a service set identifier (SSID).

When the user touches the edit box 501 to input the SSID, the controller 111 loads a real machine operation image 413 provided with a keyboard with a QWERTY layout for inputting characters in the region 402 of the display storage 171, and displays the real machine operation image 413 illustrated on a right side of FIG. 5 on the display 132.

The user inputs the SSID by the keyboard of the real machine operation image 413. The real machine operation image 413 is further provided with an OK button 502 for confirming the input SSID and a cancel button 503 for canceling the input SSID. When the user touches the OK button 502 or the cancel button 503 to confirm or cancel the input SSID, the controller 111 loads the real machine operation image 412 in the region 402 of the display storage 171, and displays the real machine operation image 412 illustrated on the left side of FIG. 5 on the display 132.

In this manner, the image displayed on the display 132 is switched to the real machine operation image 413 when the edit box 501 of the real machine operation image 412 is touched by the user, and is switched to the real machine operation image 412 when the OK button 502 or the cancel button 503 of the real machine operation image 413 is touched by the user.

Next, display on the display 231 of the PC 201 at the time of remote operation will be described.

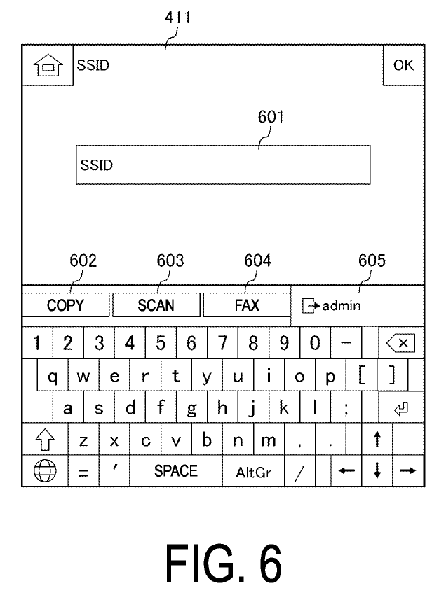

FIG. 6 is an example of the remote operation image displayed on the display of the PC. Specifically, FIG. 6 is an example of the SSID setting screen.

When remotely operating the MFP 101, first, the processor 211 reads out the remote operation application from the storage 221 for execution, transmits the connection request to the MFP 101, and is connected to the MFP 101. The processor 211 transmits the resolution of the display 231 to the MFP 101, and the controller 111 compares the resolution of the display 231 with the resolution of the display 132 and determines which of the resolutions is higher. As described above, in the embodiment, the resolution of the display 231 is higher than the resolution of the display 132, and thus the controller 111 determines that the resolution of the display 231 is higher.

Since it is determined that the resolution of the display 231 is higher than the resolution of the display 132, the controller 111 reads out the remote operation image 411 loaded in the region 401 of the display storage 171, and transmits the remote operation image 411 to the PC 201 via the communicator 151.

The communicator 251 receives the remote operation image 411 from the MFP 101, and the processor 211 displays the remote operation image 411 on the display 231. As a result, the remote operation image 411, which is the SSID setting screen as illustrated in FIG. 6, is displayed on the display 231.

The remote operation image 411 is provided with an edit box 601 for inputting the SSID, a copy button 602 for shifting to a copy mode for performing copying, a scan button 603 for shifting to a scan mode for performing scanning, a fax button 604 for shifting to a fax mode for performing faxing, a logout button 605 for a logged-in user to log out, and the keyboard with the QWERTY layout for inputting characters. The copy button 602, the scan button 603, and the fax button 604 are examples of switching buttons for switching between a plurality of the modes.

The user inputs the SSID to the edit box 601 using the keyboard of the remote operation image 411 with a mouse, a touch pen, or the like. Since the remote operation image 411 is provided with the keyboard, screen switching at the time of remote operation does not occur unlike the case where the MFP 101 is directly operated as described with reference to FIG. 5.

Further, the remote operation image 411 is provided with the copy button 602, the scan button 603, the fax button 604, and the logout button 605, which are not provided in the real machine operation image 413. This enables the user to select the copy button 602, the scan button 603, or the fax button 604 to shift from the remote operation image 411, which is the SSID setting screen, to the operation screen in the mode (the copy mode, the scan mode, or the fax mode) for using another function (copying, scanning, or faxing) without returning to a home screen or the like, which is a screen for switching between the modes. Further, the user can log out by selecting the logout button 605 from the remote operation image 411, which is the SSID setting screen, without returning to the home screen or the like.

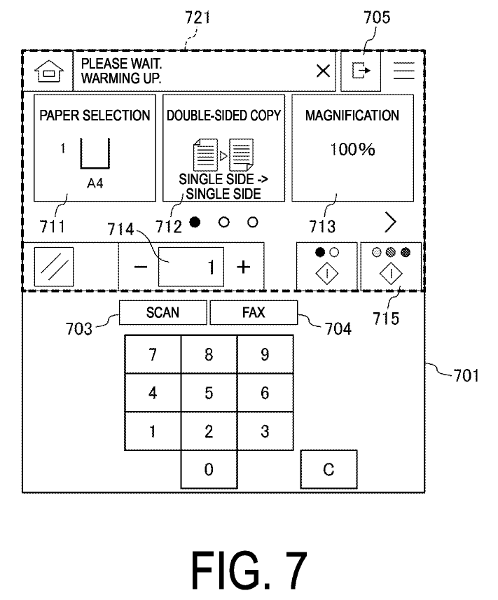

FIG. 7 is an example of the remote operation image displayed on the display of the PC. Specifically, FIG. 7 is an example of the operation screen in the copy mode.

When the mode is shifted to the copy mode at the time of remote operation, the controller 111 loads a remote operation image 701 in the copy mode in the region 401 of the display storage 171, and transmits the remote operation image 701 to the PC 201. The communicator 251 receives the remote operation image 701 from the MFP 101, and the processor 211 displays the remote operation image 701 on the display 231. As a result, the remote operation image 701, which is the operation screen in the copy mode as illustrated in FIG. 7, is displayed on the display 231.

The remote operation image 701 is provided with a scan button 703, a fax button 704, a logout button 705, a paper selection button 711, a single-sided copy/double-sided copy selection button 712, a magnification setting button 713, an edit box 714, a start button 715, and the like. In addition, the remote operation image 701 is further provided with a numeric keypad for inputting numbers in the edit box 714. The scan button 703 and the fax button 704 are examples of the switching buttons for switching between the plurality of modes. The controller 111 changes the switching buttons displayed on the remote operation image 701 according to the currently set mode. To be more specific, since the MFP 101 is currently set to the copy mode and the operation screen in the copy mode is displayed, the remote operation image 701 is not provided with the copy button for shifting to the copy mode that is less necessary to be selected. Note that the remote operation image 701 may be provided with the copy button, and in this case, the copy button may be provided in a non-selectable state such as grayed out.

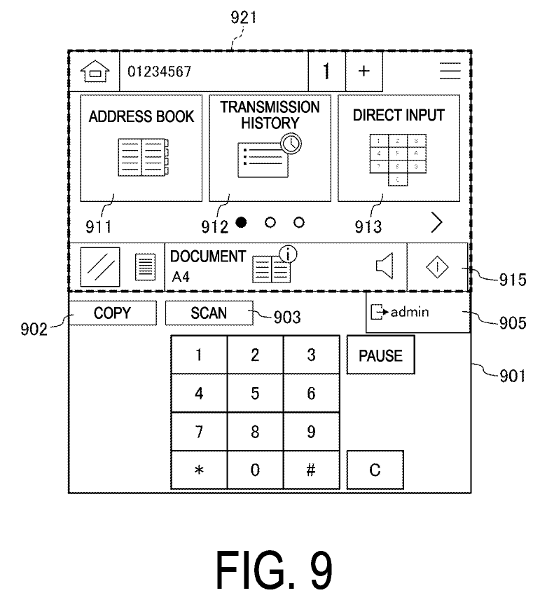

Further, since the logout button 705 is provided in an upper right region of the remote operation image 701, the logout button is not provided in a lower region unlike the remote operation image 411 of FIG. 6. Note that the logout button may also be provided in the lower region of the remote operation image 701, and in this case, the logout button may be provided in the non-selectable state such as grayed out. In addition, when the logout button is provided in the lower region of the remote operation image 701, the logout button including only an icon indicating logout similarly to the logout button 705 may be displayed, but as illustrated in FIGS. 6 and 9, the logout button including the icon indicating logout and a character string indicating a name of the logged-in user may be displayed.

Note that on the display 132 of the MFP 101, the real machine operation image corresponding to a portion of a region 721 surrounded by a broken line of the remote operation image 701 is displayed as the real machine operation screen in the copy mode. Further, when the edit box 714 is touched, the numeric keypad is displayed on the display 132 as the real machine operation screen. Note that the real machine operation screen including the numeric keypad displayed on the display 132 is not provided with the scan button and the fax button.

On the other hand, the remote operation image 701 is provided with the scan button 703 and the fax button 704. This enables the user to select the scan button 703 or the fax button 704 to shift from the copy mode to the scan mode or the fax mode without returning to the home screen or the like, which is the screen for switching between the modes, at the time of remote operation.

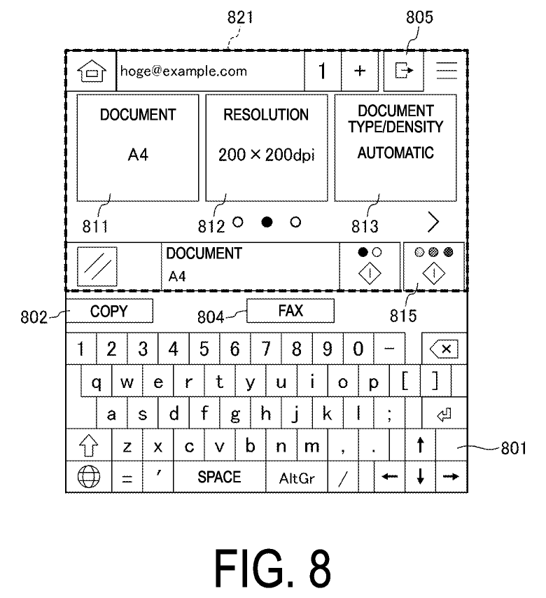

FIG. 8 is an example of the remote operation image displayed on the display of the PC. Specifically, FIG. 8 is an example of the operation screen in the scan mode.

When the mode is shifted to the scan mode at the time of remote operation, the controller 111 loads a remote operation image 801 in the scan mode in the region 401 of the display storage 171, and transmits the remote operation image 801 to the PC 201. The communicator 251 receives the remote operation image 801 from the MFP 101, and the processor 211 displays the remote operation image 801 on the display 231. As a result, the remote operation image 801, which is the operation screen in the scan mode as illustrated in FIG. 8, is displayed on the display 231.

The remote operation image 801 is provided with a copy button 802, a fax button 804, a logout button 805, a document size selection button 811, a resolution selection button 812, a document type/density selection button 813, a start button 815, and the like. In addition, the remote operation image 801 is further provided with the keyboard with the QWERTY layout for inputting characters.

The controller 111 changes switching buttons displayed on the remote operation image 801 according to the currently set mode. To be more specific, since the MFP 101 is currently set to the scan mode and the operation screen in the scan mode is displayed, the remote operation image 801 is not provided with the scan button for shifting to the scan mode that is less necessary to be selected. Note that the remote operation image 801 may be provided with the scan button, and in this case, the scan button may be provided in the non-selectable state such as grayed out.

Further, since the logout button 805 is provided in an upper right region of the remote operation image 801, the logout button is not provided in a lower region unlike the remote operation image 411 of FIG. 6. Note that the logout button may be provided in the lower region of the remote operation image 801, and in this case, the logout button may be provided in the non-selectable state such as grayed out. In addition, when the logout button is provided in the lower region of the remote operation image 801, the logout button including only the icon indicating logout similarly to the logout button 805 may be displayed, but as illustrated in FIGS. 6 and 9, the logout button including the icon indicating logout and a character string indicating a name of the logged-in user may be displayed. The copy button 802 and the fax button 804 are examples of the switching buttons for switching between the plurality of modes.

Note that on the display 132 of the MFP 101, the real machine operation image corresponding to a portion of a region 821 surrounded by a broken line of the remote operation image 801 is displayed as the real machine operation screen in the copy mode. Further, when a transmission destination display region before a transmission destination is set (FIG. 8 illustrates a state in which "hogeexample.com" is set as a transmission destination) or a destination addition button ("+" button) provided on a left side of the logout button 805 is touched, the keyboard with the QWERTY layout is displayed on the display 132 as the real machine operation screen. Note that the real machine operation screen including the numeric keypad displayed on the display 132 is not provided with the copy button and the fax button.

On the other hand, the remote operation image 801 is provided with the copy button 802 and the fax button 804. This enables the user to select the copy button 802 or the fax button 804 to shift from the scan mode to the copy mode or the fax mode without returning to the home screen or the like, which is the screen for switching between the modes, at the time of remote operation.

FIG. 9 is an example of the remote operation image displayed on the display of the PC. Specifically, FIG. 9 is an example of the operation screen in the fax mode.

When the mode is shifted to the fax mode at the time of remote operation, the controller 111 loads a remote operation image 901 in the fax mode in the region 401 of the display storage 171, and transmits the remote operation image 901 to the PC 201. The communicator 251 receives the remote operation image 901 from the MFP 101, and the processor 211 displays the remote operation image 901 on the display 231. As a result, the remote operation image 901, which is the operation screen in the fax mode as illustrated in FIG. 9, is displayed on the display 231.

The remote operation image 901 is provided with a copy button 902, a scan button 903, a logout button 905, an address book button 911, a transmission history button 912, a direct input button 913, a start button 915, and the like. In addition, the remote operation image 901 is further provided with a fax numeric keypad for inputting a fax number.

The controller 111 changes the switching buttons displayed on the remote operation image 901 according to the currently set mode. To be more specific, since the MFP 101 is currently set to the fax mode and the operation screen in the fax mode is displayed, the remote operation image 901 is not provided with the fax button for shifting to the fax mode that is less necessary to be selected. Note that the remote operation image 901 may be provided with the fax button, and in this case, the fax button may be provided in the non-selectable state such as grayed out. The copy button 902 and the scan button 903 are examples of the switching buttons for switching between the plurality of modes.

Note that on the display 132 of the MFP 101, the real machine operation image corresponding to a portion of a region 921 surrounded by a broken line of the remote operation image 901 is displayed as the real machine operation screen in the fax mode. Further, when the direct input button 913, a transmission destination display region before a transmission destination is set (FIG. 9 illustrates a state in which "01234567" is set as a transmission destination), or a destination addition button ("+" button) provided at an upper part of the image is touched, the fax numeric keypad is displayed on the display 132 as the real machine operation screen. Note that the real machine operation screen including the fax numeric keypad displayed on the display 132 is not provided with the copy button, the scan button, and the logout button.

On the other hand, the remote operation image 901 is provided with the copy button 902, the scan button 903, and the logout button 905. This enables the user to select the copy button 902 or the scan button 903 to shift from the fax mode to the copy mode or the scan mode without returning to the home screen or the like, which is the screen for switching between the modes, at the time of remote operation. In addition, in the fax mode at the time of remote operation, the user can select the logout button 905 to log out without returning to the home screen or the like.

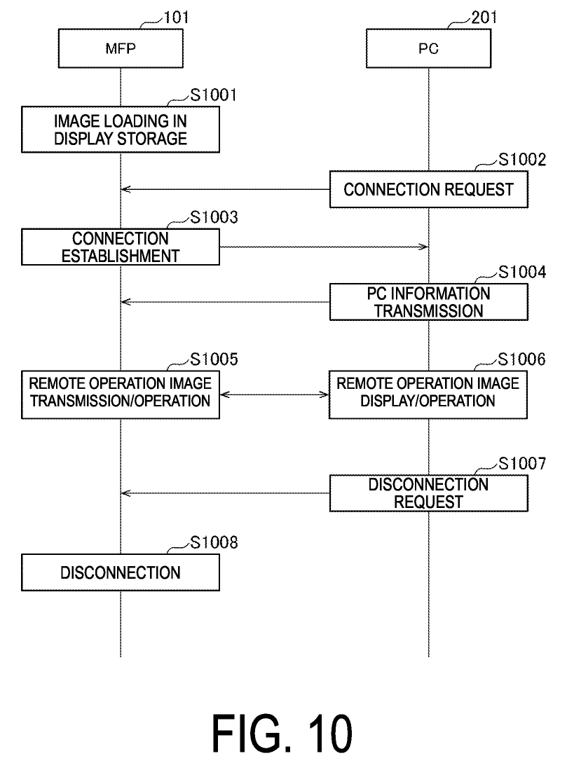

FIG. 10 is a sequence diagram illustrating a control method of a system according to the embodiment.

In step S1001, the controller 111 loads the remote operation image including the switching buttons for the modes and the logout button in the display storage 171. Further, the controller 111 may display a part of the remote operation image loaded in the display storage 171 on the display 132 as the real machine operation image. Further, the controller 111 may load only the real machine operation image in the display storage 171. In this case, for example, when it is determined in step S1005 described below that the resolution of the display 231 is higher than the resolution of the display 132, the remote operation image including the mode switching buttons and the logout button is loaded in the display storage 171.

In step S1002, the processor 211 executes the remote operation application and transmits the connection request to the MFP 101 via the communicator 251.

In step S1003, the communicator 151 receives the connection request from PC 201, and the controller 111 establishes a connection with the PC 201.

In step S1004, the processor 211 transmits information of the PC 201 including the resolution of the display 231 and the like to the MFP 101 via the communicator 251.

In step S1005, the communicator 151 receives the information of the PC 201 including the resolution of the display 231 and the like, and the controller 111 determines which of the resolution of the display 132 and the resolution of the display 231 is higher. As described above, in the embodiment, since the resolution of the display 231 is higher than the resolution of the display 132, it is determined that the resolution of the display 231 is higher. Since it is determined that the resolution of the display 231 is higher, the controller 111 transmits the remote operation image loaded in the display storage 171 to the PC 201 via the communicator 151. Note that when it is determined that the resolution of the display 132 is higher or the resolutions of the display 132 and the display 231 are the same as each other, the controller 111 may transmit a part of the remote operation image (for example, the real machine operation image) loaded in the display storage 171 to the PC 201 via the communicator 151 so that the operation images displayed on the display 132 and the display 231 are the same as each other.

In step S1006, the communicator 251 receives the remote operation image, and the processor 211 displays the remote operation image on the display 231 and remotely operates the MFP 101 using the remote operation image.

The controller 111 operates the MFP 101 in accordance with the remote operation by the PC 201, and performs loading of a new remote operation image in the display storage 171 and transmission of the new remote operation image to the PC 201 in accordance with the remote operation. Thereafter, the remote operations between the MFP 101 and the PC 201 and the transmission of a new remote operation image according to the remote operation are repeatedly performed until a disconnection request is transmitted.

In step S1007, the processor 211 transmits the disconnection request of the remote operation to the MFP 101.

In step S1008, the communicator 151 receives the disconnection request from the PC 201, and the controller 111 disconnects the communication with the PC 201.

For example, when the user switches from the function currently being used to another mode such as copying, scanning, or faxing during an operation by the display operation inputter 131 of the MFP 101, the user needs to touch the button for shifting to the other mode. However, since the resolution of the display 132 of the MFP 101 is low, the operation screen including the keyboard and the like does not have a space for displaying the button for shifting to the other mode, and the button for shifting to the other mode is not displayed at all times. Therefore, when the MFP 101 is operated by the display operation inputter 131, the user needs to perform an operation such as returning to the home screen, which is the screen for switching between the modes, in order to shift to the other mode. In addition, when the user logs out, an operation such as returning to the home screen is required. The same applies to a case where the same screen as that on the display 132 in the MFP 101 is displayed on the display 231 of the PC 201 at the time of remote operation.

On the other hand, in the embodiment, the PC 201 always displays the buttons for switching between the modes such as copying, scanning, and faxing together with the keyboard or the numeric keypad on the remote operation screen, and thus an operation such as returning to the home screen for switching between the modes is not necessary. Further, since the logout button is always displayed on the remote operation screen, the user does not need to perform an operation such as returning to the home screen when logging out. As described above, according to the system of the embodiment, it is possible to improve operability at the time of remote operation.

Note that the present disclosure is not limited to the embodiment described above and may be modified, and the above-described configuration can be replaced with a configuration that is substantially the same as the configuration illustrated in the embodiment described above, a configuration that achieves the same operations and effects, or a configuration that can achieve the same object.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An image forming apparatus that is remotely operable by an information processing apparatus including a first display that displays a first operation image as a remote operation image, the image forming apparatus comprising:
a second display that displays a second operation image as an image forming apparatus operation image for operation of the image forming apparatus;
a communicator that communicates with the information processing apparatus;
a display storage in which the first operation image is loaded; and
one or more controllers that transmit the first operation image including the second operation image as a part of the first operation image to the information processing apparatus when a resolution of the first display is higher than a resolution of the second display.

2. The image forming apparatus according to claim 1, wherein
the first operation image includes the second operation image and a third image based on the image forming apparatus operation image different from the second operation image.

3. The image forming apparatus according to claim 2, the image forming apparatus having a plurality of modes, wherein
the one or more controllers form the third image by including a switching button that switches between the plurality of modes in the image forming apparatus operation image different from the second operation image.

4. The image forming apparatus according to claim 3, wherein
the one or more controllers change the switching button to be included in the image forming apparatus operation image different from the second operation image according to a mode currently performed among the plurality of modes.

5. The image forming apparatus according to claim 2, wherein
the one or more controllers form the third image by including a logout button for a user to logout in the image forming apparatus operation image different from the second operation image.

6. A control method for an image forming apparatus that is remotely operable by an information processing apparatus including a first display that displays a first operation image as a remote operation image, the image forming apparatus including a second display that displays a second operation image as an image forming apparatus operation image for operation of the image forming apparatus, the control method comprising processing of:
communicating with the information processing apparatus;
loading the first operation image; and
transmitting the first operation image including the second operation image as a part of the first operation image to the information processing apparatus when a resolution of the first display is higher than a resolution of the second display.

7. A system including an image forming apparatus and an information processing apparatus allowed to remotely operate the image forming apparatus, wherein
the information processing apparatus includes
a first communicator that receives a first operation image as a remote operation image that remotely operates the image forming apparatus,
a first display that displays the first operation image, and
a processor that remotely operates the image forming apparatus via the first operation image,
the image forming apparatus includes
a second display that displays a second operation image as an image forming apparatus operation image for operation of the image forming apparatus,
a second communicator that communicates with the information processing apparatus,
a display storage in which the first operation image is loaded, and
one or more controllers that transmit the first operation image including the second operation image as a part of the first operation image to the information processing apparatus when a resolution of the first display is higher than a resolution of the second display.
